(19) United States
(12) Patent Application Publication
(10) Pub. No.: US 2026/0301401 A1
(43) Pub. Date: Oct. 1, 2026

(54) CONTEXTUAL 3D RENDERING ON 2D VIDEO IN XR ENVIRONMENTS

(71) Applicant: Adeia Guides Inc., San Jose, CA (US)

(72) Inventors: Mathew Adams, Matthews, NC (US); Aldis Sipolins, Somerville, MA (US); Tao Chen, Palo Alto, CA (US)

(21) Appl. No.: 19/094,528

(22) Filed: Mar. 28, 2025

(51) Int. Cl. G06V 20/20; G06T 19/00; G06V 20/70

(52) U.S. Cl. CPC G06V 20/20; G06T 19/006; G06V 20/70

(57) ABSTRACT

Systems and methods are described herein to enable providing personalized information as integrated overlays on live content in an extended reality (XR) environment. The system may receive a content stream displayed on a display screen (e.g., a physical display) captured by an XR device. The system may identify the content stream as an event relevant to an interactive application. The system may receive, based at least in part on the identifying, updated data regarding the event and, via the interactive application, data describing a participant selection related to the event. The system may generate, for view on the XR device, an overlay based at least in part on the data describing the participant selection and the updated data regarding the event and then provide the overlay for presentation at the XR device.

### BACKGROUND

The present disclosure is related to content delivery. More particularly, systems and methods are provided herein that enable providing personalized information as integrated overlays on live content in an extended reality (XR) environment.

### SUMMARY

Interactive elements of audio-visual content have become more popular in recent decades, especially for live content. Interactive elements, such as polls, trivia games, sports betting, fantasy sports, comment feeds, and other options, now commonly accompany audio visual content, especially live streaming. Conveying the accompanying feeds and information to viewers of the content can result in activity overload for users. In some scenarios, for instance, it may be difficult for viewers to find the accompanying feeds that follow what they are watching. Some approaches may force a viewer to switch between viewing the content on one screen and a secondary screen that presents the viewer's accompanying information, causing interface confusion and fatigue.

In one approach, a broadcast of an event may include a visual or announcement informing viewers of updates to the accompanying information. For example, a live feed may include a ticker at the bottom of the screen with information from the broadcast or other related broadcasts. This approach, however, is not specific to the viewer and therefore only has limited value. It cannot inform a viewer of their specific standing, such as their performance in a poll or fantasy sport league following the latest event of the content stream. It also requires that a viewer divert their view from the action in the content to another part of the display screen, potentially for an extended period, while the viewer calculates their standing.

In another approach, multiple windows may be open on one device to provide both the content and accompanying content. For example, a viewing device may have a split screen to include a football game on one half of a display and player statistics on the other. While this approach allows for customization and up-to-date scoring information, it also requires diverted attention and potentially missed moments. It additionally requires time to manually set up and maintain. There exists a need for an interface to provide content-related information, e.g., based on selection of interactive elements, as an augmentation and/or overlay in a content area.

To help overcome these problems, systems, methods, apparatuses, and computer-readable media are disclosed herein for dynamically providing an extended reality (XR) environment that delivers customized information in the same display area as the content. These systems, methods, apparatuses, and computer-readable media may recognize displayed content, for example, by using an XR device with an integrated camera to identify content. As used herein, XR may comprise and/or refer to one or more of, virtual reality (VR), augmented reality (AR), mixed reality (MR).

Some embodiments may also validate when the content is live and then collect and visually display the accompanying live information in the form of an XR overlay over the broadcast of the content the viewer is watching in the real world. Upon identifying and verifying the content, the systems, methods, apparatuses, and computer-readable media may access viewer information, such as a selection in a poll or fantasy sports roster, and content data, such as poll results or current player positions, and generate an overlay for display over the original content that communicates or otherwise integrates information about the content that is relevant to the viewer. In this manner, the display provides personalized and easy-to-see information during the content duration. This same solution can just as easily deliver contextual advertising into, onto, and/or around a video stream or broadcast as well.

In some embodiments of this approach, the systems, methods, apparatuses, and computer-readable media provide an overlay highlighting key moves or statistics within the content. In some embodiments, the systems, methods, apparatuses, and computer-readable media provide additional information not otherwise shown in the content.

### BRIEF DESCRIPTION OF THE DRAWINGS

FIG. 1 depicts a system for providing content overlays based on a participant selection and updated content data, in accordance with some embodiments of the disclosure;

FIG. 2A depicts an example view of the system from an XR device, in accordance with some embodiments of the disclosure;

FIG. 2B depicts a detailed view of the system from an XR device, in accordance with some embodiments of the disclosure;

FIG. 2C depicts an alternative detailed view of the system from an XR device, in accordance with some embodiments of the disclosure;

FIG. 3A depicts an example view of the display located within the display of the XR device, in accordance with some embodiments of the disclosure;

FIG. 3B depicts an example translated view of the display located within the display of the XR device, in accordance with some embodiments of the disclosure;

FIG. 4 is a flowchart of an example process of an automatic content recognition (ACR) system, in accordance with some embodiments of the disclosure;

FIG. 5 is a flowchart of an example high-level workflow of the system, in accordance with some embodiments of the disclosure;

FIG. 6 is a sequence diagram of integrating polls into a live sporting event, in accordance with some embodiments of the disclosure;

FIGS. 7A and 7B depict an example advertising embodiment of the system viewed through an XR device, in accordance with some embodiments of the disclosure;

FIG. 8 depicts an example embodiment in which the system integrating third-party data into an overlay, in accordance with some embodiments of the disclosure;

FIG. 9 depicts an example generated camera view of the system, in accordance with some embodiments of the disclosure;

FIGS. 10-11 depict illustrative devices, systems, servers, and related hardware for generating overlays, in accordance with some embodiments of this disclosure; and

FIG. 12 is an illustrative flowchart of a process for providing content overlays, in accordance with some embodiments of this disclosure.

### DETAILED DESCRIPTION

The present disclosure describes, at least in part, systems and methods for displaying personalized supplemental information during a live broadcast. In some embodiments, the system may access viewer data along with dynamic, up-to-date content state data to generate an XR device overlay on top of a presentation of the original content.

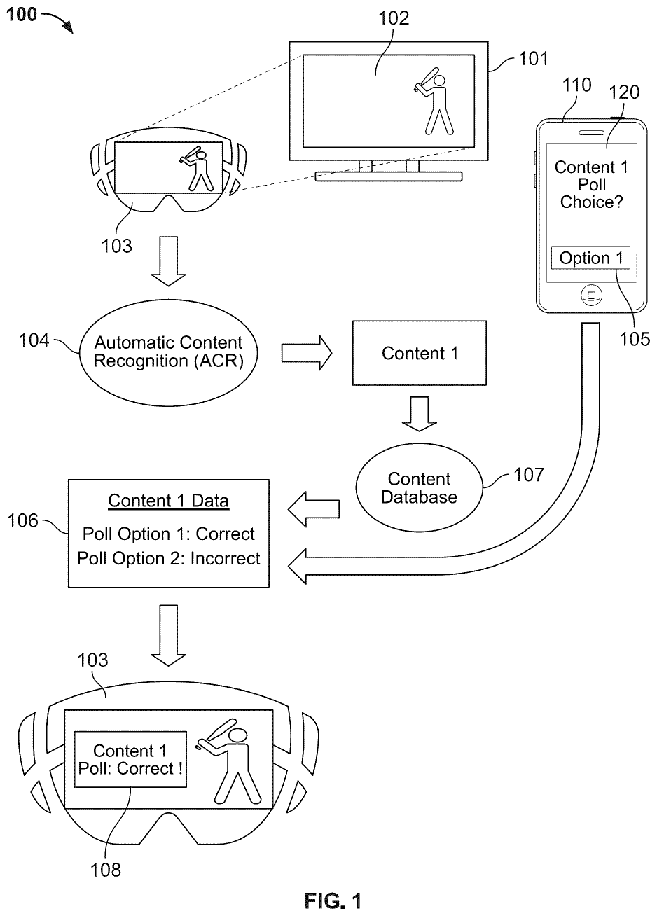

FIG. 1 shows an example embodiment of an overlay system 100. Overlay system 100 includes a display device 101 presenting content 102. Display device 101 may correspond to or comprise, for example, a headset; a mobile device such as, for example, a smartphone or tablet; a laptop computer; a personal computer; a desktop computer; a smart television; a smart watch or wearable device; a stereoscopic display; or any other suitable user equipment or device capable of presenting content; or any combination thereof. Content 102 may be, for example, a live video stream or other audio and/or visual presentation.

XR device 103 locates the display 101 and views the content 102 as presented on display device 101. In some embodiments, the XR device 103 views the content 102 through an integrated camera connected to a head-mounted display (HMD) or other display screen of the XR device. In some embodiments, the XR device mirrors content 102 on its own display.

XR device 103 may correspond to or comprise, for example, a headset; a mobile device such as, for example, a smartphone or tablet; a video game console or any other suitable video game platform; a laptop computer; a personal computer; a desktop computer; a smart television; a smart watch or wearable device; smart glasses; an XR HMD; a stereoscopic display; a wearable camera; XR glasses; XR goggles; a near-eye display device; or any other suitable user equipment or device capable of presenting extended reality; or any combination thereof.

In some embodiments, the XR device 103 detects and defines the display 101 as it shows the content 102. This detection may be by a video detection and analysis system that might use a trained machine learning model, like a Compromised Metric via Optimal Transport (CMOT) or YOLO, that would recognize the type(s) of content compatible with the specific embodiment of the system 100. For example, in an embodiment in which the overlay system 100 is designed for polling during a sporting event, compatible content may be televised footage of sporting events for which there exists a poll that poses questions about the event for viewers to answer or vote on. In another embodiment, the overlay system 100 is designed for advertising and compatible content may be specific video or images that the advertiser or advertisement aims to overlay, such as, for example, XR static, specific ad content, or a video scene.

The overlay system 100 may, in some embodiments, detect the display 101 and return the location(s) in the XR view that contain the detected video. The overlay system 100 may then be able to transform this location from three-dimensional space into a two-dimensional image that can then be shared with an automatic content recognition (ACR) system 104 that may then identify the content 102.

In some embodiments, the overlay system runs on the XR device 103 to minimize bandwidth and transmission time. In some embodiments, for example those in which the XR device is not capable of running the overlay system, the overlay system 100 may be integrated into the ACR system 104, and the XR device 103 streams a live view to an external ACR system 104.

The overlay system 100, using the two-dimensional image or other input from the XR device 103, may forward the data of the content 102 to the ACR system 104 for identification via a wired or wireless communication connection.

The data of the content 102 may be, for example, portions of the audio or visual components of the content 102 that the XR device 103 has captured, metadata of the content 102 available to the overlay system 100, or any other data that may contribute to identifying the content 102. In some embodiments, the overlay system 100 may retrieve data regarding the content 102 from the display 101. For example, the display may be a smart TV that captures user data and metadata about content 102. The overlay system 100, and ACR system 104, may use such data to identify the content 102.

In some embodiments, to identify content 102, the ACR system 104 may compare the data related to the content 102 to existing identified data in a database. For example, the ACR system 104 may compare frames of content 102 to frames in a database of known content items and, upon finding a matching frame, identify the content 102 as that of the known content item with the matching frame. In some embodiments, the ACR system 104 creates a fingerprint of the data related to the content 102 to simplify the comparison process. These processes may use computer vision or audio recognition algorithms, content metadata, or other means to identify content 102. In the example shown in FIG. 1, the ACR system 104 has identified content 102 as “Content 1.”The ACR system 104 may, in some embodiments, determine or identify what content is displayed on the display 102 and whether it is content compatible with the overlay system 100. For example, in the context of polling, the ACR system may determine whether the display shows a live broadcast of specific sporting events, or other content, to which polling applies or is available. In polling scenarios, the overlay system 100 may then determine that the event on the display is currently live, and that the display shows the current state of the event without a significant delay that would impact the timing of a poll entry (i.e., that the game has not been paused and running behind the live broadcast in a manner which would mean the timing of certain time-critical selections is no longer active).

In some embodiments, if the ACR system 104 also detects a delayed state, the overlay system 100 may display a notice indicating this information. The overlay system 100 may then, upon displaying the notice, receive a user selection to synchronize with the live broadcast, returning the presentation to a point within a live broadcast timeline in which the overlay system 100 allows active polling or other interaction. Otherwise, when the display is in a delayed state, the overlay system 100 will only display options of interactions that are not affected or invalidated by delays.

Once the overlay system 100 has identified the content 102, the overlay system 100 may access a participant selection 105. A participant selection 105 may be, for example, a selection within a poll, a user's fantasy sports roster and/or league details, an answer to a trivia contest, or any other interactive choice relevant to the identified content 102. The overlay system 100 may receive the participant selection 105 through a user device 110, as seen in FIG. 1. The user device 110 may be any device, application, or service capable of receiving input such as a smartphone, personal computer, smart TV, tablet, HMD remote, or other device, application, or service. For example, in some embodiments, the overlay system 100 receives the participant selection 105 through an application, such as interactive application 120, in communication with system 100. In the example shown in FIG. 1, the interactive application 120 is a polling smartphone application. The application may be a third-party application that collects data from a group of participants and shares or compares entries and/or outcomes. For example, the interactive application 120 may collect poll entries from a number of users (e.g., 3, 32, or 24,567) and return statistics and results of the poll, such as informing a participant if they have selected a correct response and/or a percentage of users who selected each choice.

The overlay system 100 may access the participant selection before or during content identification. In some embodiments, the participant selection becomes available, that is, a viewer selects the participant selection, before display or broadcast of content 102. In some embodiments, the participant selection becomes available during display or broadcast of content 102. The selection and display of the participant selection may be at the same or different times.

The overlay system 100, after identifying content 102, receives content state data 106 from database 107. The content state data 106 may be any data regarding content 102 that may be relevant to system 100 or its viewer. For example, content state data 106 may be a result of an event within the content 102 on which an active poll is based, e.g., a poll in which a viewer has participated. In the example of FIG. 1, the content state data 106 is data indicating that poll option 1 is correct and poll option 2 is incorrect.

The overlay system 100 may then generate an overlay 108 based on the received participant selection 105 and content state data 106. For example, in the example shown in FIG. 1, the overlay system 100 receives information of a participant selection 105 in poll of option 1. The system also receives content state data 106 that poll option 1 is correct. Based on this information, the system generates an overlay 108 indicating that the selected poll option is correct. The overlay 108 may be an overlay positioned to be on top of the display 102 or the overlay may be on any other point within the XR view, such as a designated corner.

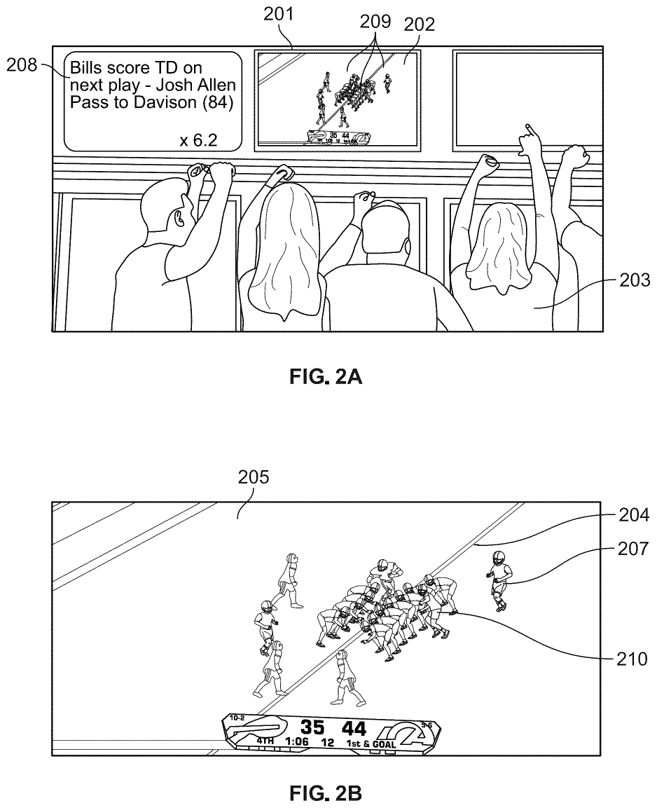

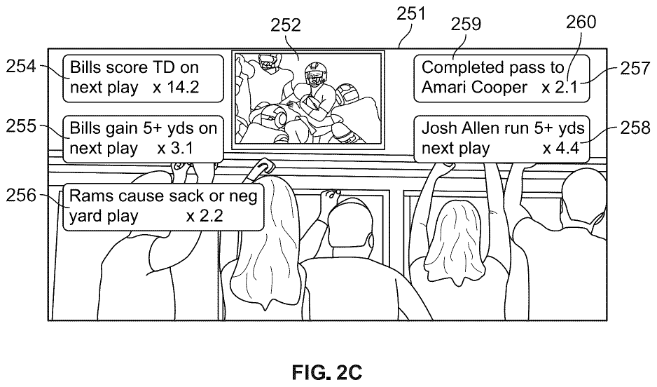

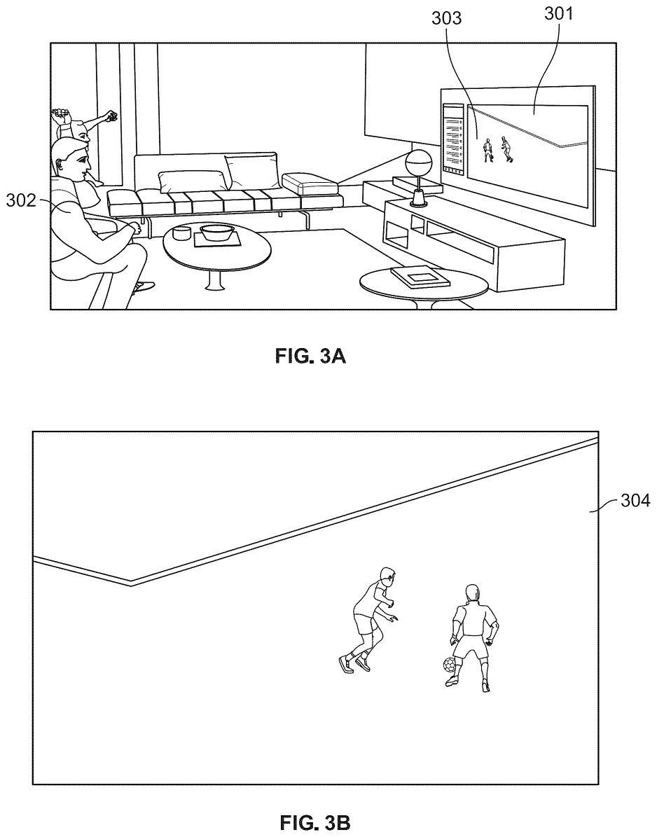

The overlay system 100 then causes display of the overlay 108 over content 102 via XR device 101 as seen in the message in FIG. 1 displaying “Content 1 Poll: Correct!” FIG. 2A shows an example view from the XR device using the overlay system 100. In this view, the XR device shows surroundings including a display 201 presenting content 202 in the form of a live sporting event, here an NFL game, and onlookers 203. The overlay system 100 highlights relevant elements 209 of the content in the XR view. That is, the overlay system 100 highlights the line of scrimmage, the end zone, the quarterback, and the scoring player. These highlights indicate that the overlay system 100 has located the display 201, using, for example, image recognition procedures, and has recognized the content 202 as an NFL game. In some embodiments, the recognition of content 202 includes details such as identifying a specific NFL game, here the Buffalo Bills vs. the Los Angeles Rams, and the game's important figures, such as Buffalo Bills quarterback Josh Allen.

FIG. 2B shows the view of the display on the XR device in detail, with the line of scrimmage 204, the end zone 205, the quarterback 210, and the scoring player 207 highlighted. These highlights may be overlays on the XR device that align with the image of the display 201 on the XR device to create the augmented reality view of the display. In some embodiments, the overlay may also show potential paths that a player, or other content element, may take and allow a user to select for particular interest one potential path.

The view also includes an information overlay 208 in the top left corner. Placement of the information overlay may vary. In some embodiments, the placement of the information overlay may adapt to changes in the view. For example, if a second display comes into view in the top left of display 201, that is, behind the information overlay in the view on the XR device, the overlay system 100 may relocate the information overlay to a different, inactive section of the view to accommodate viewing access to the second overlay. The information overlay 208 may include any relevant information, such as, for example, scoring player, a description of a pass, a value in a related application, or any other information. In some embodiments, such as that shown, the information overlay 208 may include text information. Here, the information overlay 208 states, “Bills score TD on next play—Josh Allen pass to Davidson (84).” The information overlay 208 may relocate, disappear, and reappear throughout a viewing session or over the course of the duration of a specific content item as well.

An alternative example display is shown in FIG. 2C. Specifically, an XR overlay displaying participation selection options over a view of the XR device is shown in FIG. 2C. In FIG. 2C is an XR device view 251, showing a display 252 and onlookers 253. The overlay system 100 determines and displays as an overlay on top of the view 251 participation selection options 254-258. In some embodiments, such as that seen in FIG. 2C, the participation selection options may include a description 259 of the participation selection and a point value 260. In some embodiments, the point value 260 corresponds to an interactive game or competition within the interactive application, such as interactive application 120. In some embodiments, the overlay system 100 may dynamically reposition the participation selection options 254-258 according to changes within view 251. For example, if a second display appears with view 251, the overlay system 100 may reposition one or more of participation selection options 254-258 to avoid obstructing the view of the second display.

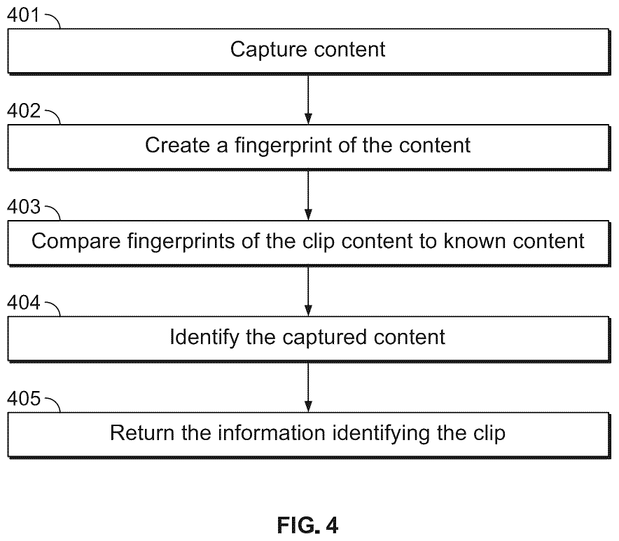

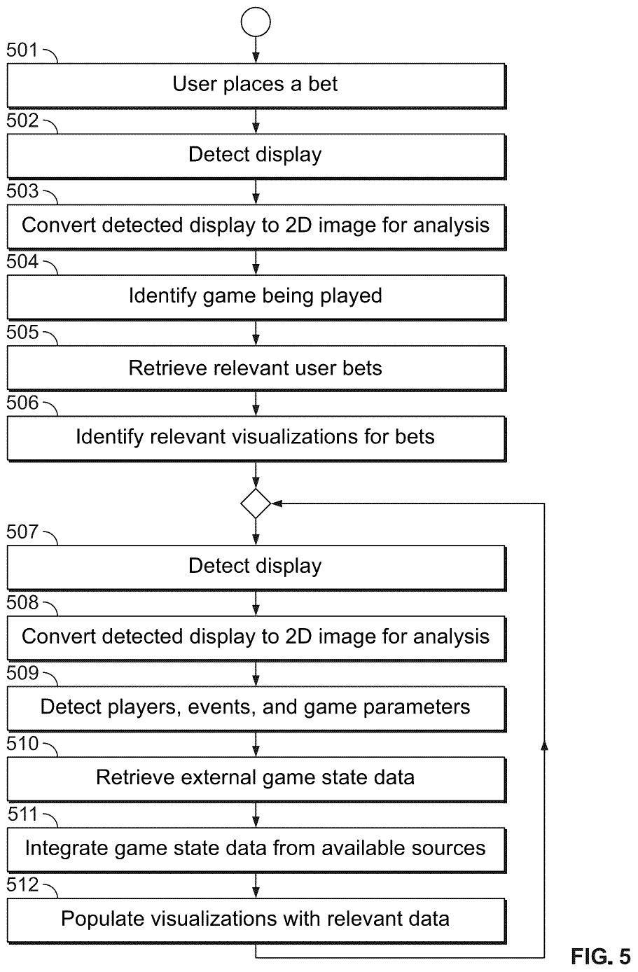

FIG. 3A shows a second example view from the XR device using the overlay system 100. In this view, the XR device shows a room with a display 301 and onlookers 302. Using broadcast detection logic, including for example image recognition, neural networks, other algorithms, simultaneous localization and mapping (SLAM) data, location data, or other available information, the overlay system 100 detects the display 301 within the view. In some embodiments, the overlay system 100 combines two or more types of data to detect and locate the display. In some embodiments, the overlay system 100 determines a bounding box 303 outlining the edges of the display 301. In some embodiments, the overlay system 100 highlights the bounding box on the display of the XR device. In some embodiments, the overlay system 100 does not display the bounding box.

In some embodiments, once the overlay system 100 determines the edges of the display 301, it may correct the perspective of the display to better view the display 301. That is, if the view of the display 301 on the XR device is skewed and/or angled due to perspective, the overlay system 100 may adjust the presentation of the display 301 on the XR device to be a head-on perspective, that is, the bounding box includes four right angles. The overlay system 100 may then show the display 301 without distortion. An example of the resulting adjusted view of the display 304 is shown in FIG. 3B.

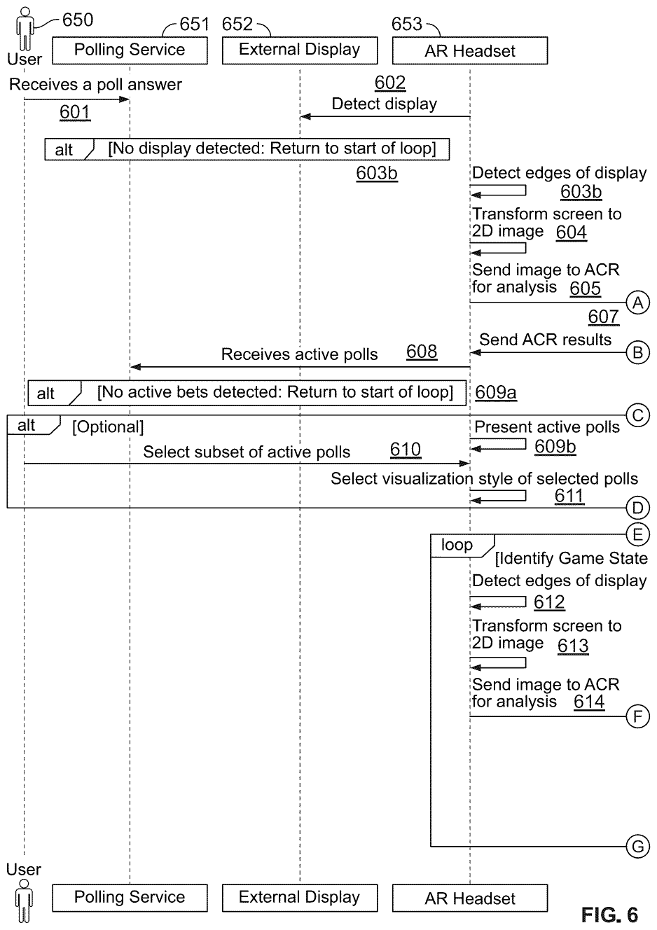

FIG. 4 shows a flowchart of an example process of ACR system 104. At step 401, the overlay system 100 captures content from the display. For example, the ACR may select or receive a short clip of audio, video, or a combination thereof from the content being played. In some embodiments, the clip is a portion of content available to the ACR. In such embodiments, the ACR may select the clip based on a selection algorithm or other instructions. In some embodiments, the ACR uses all available data.

At step 402, the overlay system 100 creates a fingerprint of the content. In some embodiments, the ACR analyzes the audio and/or visual elements of the clip to create a digital fingerprint. The ACR analysis of the clip may be, for example, based on an image processing algorithm, an audio processing algorithm, and/or a machine learning algorithm. The fingerprint may be, for example, image analysis of one frame of the content or statistical data of a series of frames.

At step 403, the overlay system 100 compares fingerprints of the clip content to those of known content. In some embodiments, the ACR compares the fingerprints it has created to known fingerprints in a database or repository of known content. For example, a database may include fingerprints of live sports broadcasts and their identifying information. The ACR may then compare the fingerprints of the content it has created to all of the fingerprints in the database to find a fingerprints match. In some embodiments, the ACR may compare the fingerprints to only a portion of the fingerprints in the database. For example, the ACR may filter the database entries to those most likely to match, such as the most recent entries, the entries with a similar profile, or entries from a specific provider.

A fingerprint match may, in some embodiments, require an exact match. In some embodiments, the ACR may tolerate a degree of uncertainty and determine a match if a calculated or designated percentage of the fingerprints align. In some embodiments, the ACR may include a confidence level, that is, a percentage of a fingerprint that matches a database entry. Such a confidence level may be specific to a user, content type, application, or other quality.

At step 404, the overlay system 100 identifies the captured content. That is, if the ACR system finds that the created fingerprint matches a fingerprint entry in the database, the ACR system identifies the clip as the content of the matching fingerprint. For example, the ACR system may compare a created fingerprint to a list of entries in a database and find that one of the entries is an exact match to the created fingerprint. The ACR system may then, using the data, determine an identifier of the content of the matching fingerprint, such as a name, date, or provider. The ACR system may then determine and identify that the clip from which the created fingerprint is made is the content of the matching fingerprint.

At step 405, the overlay system 100 returns the information identifying the clip. In some embodiments, the ACR system returns the identifying information of the clip, determined above at step 404, to the XR device. The XR device may then display this information, forward it to an application, or otherwise incorporate the information into a process.

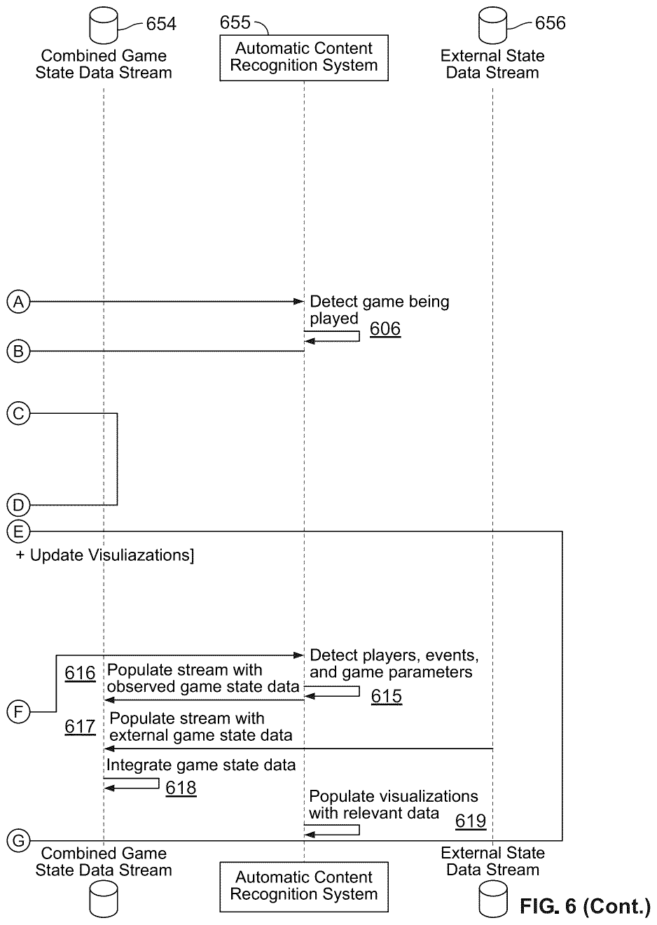

FIG. 5 shows a high-level flowchart of the overall process of one embodiment of the overlay system 100. At step 501, a user makes a selection regarding streamed content, such as participation selection 105. For example, as seen in FIG. 5, a user places a bet. The selection may be through, for example, an application, such as interactive application 120 of FIG. 1, or other service, such as user device 110, as discussed above.

At 502, the overlay system 100 detects a display, such as display 101. This detection may use, for example, location data or image recognition methods, as discussed in connection with FIGS. 1 and 3A. The display may show, for example, a live sporting event or other audio or visual content, such as content 102. In some embodiments, the display shows content related to the user selection, such as a game on which a user has placed a bet.

At step 503, the overlay system 100 converts the detected display to a two-dimensional image for analysis. This conversion may be by, for example, an image processing algorithm.

At step 504, the overlay system 100 identifies content played on the display. In some embodiments, such as that shown in FIG. 1, the overlay system 100 collects data related to the content, such as images or audio, via, for example, an XR device. The overlay system 100 may forward this data to an ACR system, such as ACR system 104 shown in FIG. 1, which processes the data to determine an identification of the content, as discussed in detail below in relation to FIG. 4.

At step 505, the overlay system 100 retrieves relevant participant selections. The relevant selections may include, for example, a polling selection, a trivia answer, or other choice related to the content. In some embodiments, viewers select these participant selections via a user device, such as a smartphone or XR device, as seen in FIG. 1. The user device or other functionality receiving the participant selections may then forward the selection to an application, database, or server what can communicate the selections to the overlay system 100.

At step 506, the overlay system 506, identifies relevant visualizations for bets. At step 507, the overlay system 100 detects the display again and, again, at step 508, the overlay system 100 converts the detected and captured display to a two-dimensional image for analysis.

At step 509, the overlay system 100 detects relevant elements of the content. The overlay system 100 may determine relevant elements based on the content identification. The relevant elements may include information such as key players, events, and parameters. The detection may be by, for example, image recognition software or data available to the overlay system 100 through, for example, third parties such as content providers.

At step 510, the overlay system 100 retrieves external content state data, such as content state data 106 of FIG. 1. The content state data may indicate changes in the content. For example, where the content is a sports game, the content data may indicate a play, change in score, or update to player statistics. In the context of a trivia game, the content state data may include information such as correct answers to trivia questions or remaining time in a round.

At step 511, the overlay system 100 integrates content state data from available sources. In some embodiments, the overlay system 100 receives content state data from more than one source. Multiple sources may include content providers, third-party applications, or image analysis engines. The overlay system 100 may receive this data and combine it to apply to the content state data.

At step 512, the overlay system 100 populates visualizations with relevant data. The overlay system 100 may generate for display visualizations, such as notifications or highlights, related to a content item. For example, in the context of a trivia game, the overlay system 100 may prepare a visual notice of questions and answers and their value in the game. The overlay system 100 may then, using the content state data, update the visualizations with new information, such as correct answers or percentage of users answering correctly.

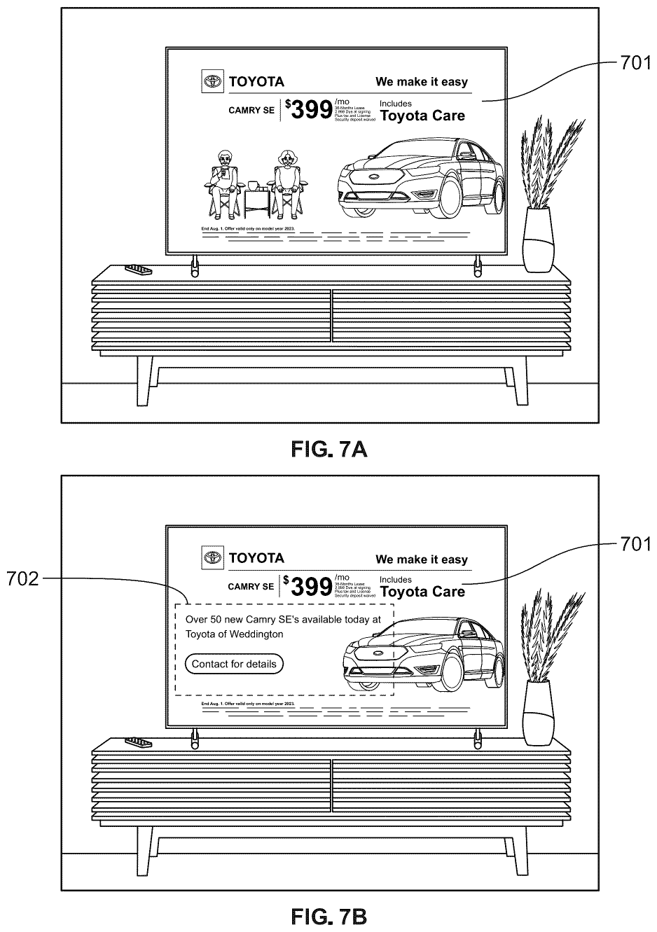

FIG. 6 is a sequence diagram of one embodiment of the invention integrating polls into a live sporting event. At step 601, polling service 651 receives a poll answer selection from user 650. The polling service may receive the poll answer selection via, for example, a wired or wireless connection to an application or user device, such as interactive application 120 on user device 110 of FIG. 1. The polling service 651 may also receive the selection via direct input, such as through a selection on an application.

At step 602, an augmented reality (AR) headset 653 detects external display 652. Such an AR headset may be an example of XR device 103. The detection may be through, for example, image recognition software within the AR headset, as described above. In some embodiments, display detection and/or content identification may be via network communication such as Wi-Fi, NFC, Bluetooth. If, alternatively, the AR headset 652 does not detect a display, it returns to step 602, to search for a display.

In some embodiments, at step 603, the AR headset 653 detects edges of the external display 652, for example, through image recognition. Once the AR headset 653 has detected the edges of the display 652, it has determined the location of the display 652 and may begin, and then continue, tracking the display 652 and the content thereon.

In some embodiments, the overlay system 100 also detects video within the display 652. The overlay system 100 may accomplish video detection using a trained machine learning model, like a Compromised Metric via Optimal Transport (CMOT) or YOLO. The video detection may recognize video or frames that are of interest to the overlay system 100. The video detection may also identify the location of the video feed in the view of the AR headset. In some embodiments, the video detection may run natively on the AR headset to detect and define the location of the display in the physical world. In some embodiments, the overlay system 100 will only use the video detection to detect the screen initially. In some embodiments, the overlay system 100 includes user tracking, such as head and/or eye movement tracking to determine if a user is focused on a display area outside of the intended area of interest. In some embodiments, if the overlay system 100 detects that the user is not focused on the display, the overlay system 100 may activate the video detection to detect a second display. Such embodiments may be useful in a scenario such as a sports bar, where there may be multiple video displays for the user to engage with.

In some embodiments, once the overlay system 100 has detected the display and created a perspective corrected screenshot or captured image, as seen in FIG. 3B, the overlay system 100 sends the screenshot or captured image to the ACR system. In some embodiments, the ACR system is remote, cloud-based, or part of the backend of a betting service, or other service. At step 604, the AR headset 653 transforms the screen of the display into a two-dimensional image via image processing software or other available mechanism.

At step 605, the AR headset sends the transformed two-dimensional image to an ACR system 655 for analysis and identification. The ACR system 655, such as ACR system 104, may then, using the two-dimensional image, analyze the image to determine if the external display 652 is displaying relevant content, for example a live game for which polling is available.

At step 606, the ACR system 655 detects that the external display 652 is displaying a game. At step 607, the ACR system 655 sends its results, via, for example, an Internet connection, to the AR headset 653. In some embodiments, the ACR system 655 is within the AR headset 653.

The AR headset may then, at step 608, retrieve active polls for the detected game from the polling service 651. If no active polls are available, the AR headset 653 continues to search for available polls until it finds one or the game ends.

In some embodiments, at step 609, the AR headset 653 presents the active polls retrieved at step 608. This presentation may be through, for example, a display on the AR headset 653. The AR headset 653 may then, through a user interface, receive a selection of a subset of active polls available for participation from the presentation at step 610. The AR headset 653 may then select a visualization style for the selected polls at step 611.

Next, the AR headset 653 may identify the content state and update the poll visualization. The AR headset 653 may receive the content state from a database or other means and discussed in relation to FIG. 1. At step 612, the AR headset 653 again detects edges of the external display 652, although now at a later time, and at step 613 again transforms the screen of the external display 652 to a two-dimensional image. The AR headset 653 then may send that two-dimensional image to the ACR system 655 for analysis at 614.

The ACR system 655 may then, at step 615, based on its analysis, detect relevant elements of the content, such as players, events, and game parameters. It may, using this information, populate a combined content state data stream 654 with the observed game state data at step 616. The combined game state data stream 654 may further receive data from an external state data stream 656, which at 617 populates the combined game state data stream 654 with external data. The combined game state data stream 654 may then integrate the game state data at 618. Finally, at step 619, the ACR system 655 may populate visualizations with relevant data.

In some embodiments, a user watches a game, or other relevant content, such as content 102, on a secondary device that is not the XR device. For example, a user may watch content on a smart phone or smart TV. In some embodiments, the XR device itself has access to a broadcast and/or stream of the relevant game or content with a lower latency than the secondary device. In some embodiments, the XR device may cast the lower latency content to the secondary device for overall latency lower than that of the broadcast or stream on the secondary device, where overall latency is the latency of the content on the XR device combined with latency caused by casting. In that situation, that broadcast may be delivered through an application to the XR device, and the XR device may offer an option to cast that lower latency stream to the secondary device to allow for more real-time user selection options, such as polling.

The ACR system may determine overall latency in some embodiments. In some embodiments in which the ACR system has access to encoded or multiplexed broadcasts or streams, including timing data, the ACR system may determine latency by comparing a timestamp of the screenshot of a stream on a device with a timestamp of that frame in the original stream. In that scenario, the offset from the time in the live stream will provide the overall latency, including the latency for the delivery and processing of the screenshot by the ACR system. Once the ACR system has detected a valid broadcast of an event, the overlay system 100 can request all active selections from a user selection system. The XR device may then, in some embodiments, display the most relevant active options around its display. The XR device may also allow a selection of one or more options to simulate on its display. In some embodiments, the overlay system 100 also determines the latency between the ACR system and the local broadcast. In some embodiments, the interactive application, such as interactive application 120 of FIG. 1, will manage and track the latency of the ACR system from the true content stream time, as tracking the internal timing of the interactive application is often a crucial internal process to maintain application integrity.

In some embodiments, the interactive application, such as interactive application 120, is responsible for delivering not only active participation for the content, but also the relevant content state data. As noted above, content state data, such as content state data 106, refers to any data that could be used to create participation input, inform a decision on input, or generate graphics and overlay information. For example, for an NFL game, the content state data could include, but not be limited to: current state of the game, what yard line the ball is on, the amount of time left in the quarter, the down, the number of yards, who has possession of the ball, number of time-outs each team has; individual player data, for the game, season and career; injury status; weather and location of game; historical matchup data between the teams and players; and/or other information.

The interactive application may package up the relevant content state data for a participation selection. The overlay system 100 may use this packaged information to create visual overlays on the XR device or to aid in the object detection and tracking. For example on a poll on a likelihood of “Bills score TD on next play—Josh Allen pass to Davidson (84),” relevant data may include players relevant to the selection where the line of scrimmage is, and the desired result (here, e.g., a touchdown). The display of participant selection options may also include additional information, such as historical data, current player statistics, or other relevant information.

In some embodiments, once the overlay system 100 has the relevant video feed timing and participation selection information, it may process the local video stream using the Game Play Object Detection System (GPOD), which could be an object detection model, such as YOLO, specifically trained for the relevant content type and optimized to run on the XR device. The GPOD may also contextualize the active selections and create graphics to overlay the live video feed visualizing the components of the selections.

The overlay system 100 may also use a GPOD system to contextualize the active selections and create a graphic overlay of those selections on the live video feed via the XR device. For an NFL football game, for example, the GPOD may handle object detection and semantic segmentation of the various elements of the playing field, detect specific players on the field by their numbers, and contextually understand where on the field the current play is taking place so that when a participation selection is selected, it can be rendered correctly on top of the video frame. These tasks typically require an understanding of the camera position relative to the playing field so that the graphics and imagery can be correctly projected onto the three-dimensional surfaces that make up the playing field and players. The overlay system 100 may, in some embodiments, understand the underlying three-dimensional world that the two-dimensional video stream displays so that the graphics and imagery can be correctly projected on top of the physical display.

In some embodiments, the GPOD system runs while the XR device displays an active participation selection, that is, a participant selection that has not been finalized, such as an active poll. In some embodiments, if the camera angle or scene changes, then the GPOD will update the overlay display to accommodate the change. In some embodiments, if the active portion of the field relevant to the participation selection is no longer visible on the screen, then the overlay system 100 will disable the overlay until the camera angle or scene actively shows the correct portion of the playing field.

In some embodiments, if the overlay system 100 or gameplay data detects that important activity is not in view on-screen (for example, if the targeted receiver in the participation selection is running his route but the camera is focused on the quarterback) then the overlay system 100 may display a marker to highlight the direction and location of the off-screen action.

In some embodiments, if a participant selection is relevant to a content stream over a longer period of time, for example a poll on the outcome of the game, then the overlay displays may become more flexible and dynamic so as to, for example, display other potential polls, display updates on input polls, or indicate actions on the field that impact poll outcome odds.

In some embodiments, there are four core sub-systems within the overlay system 100: the broadcast detection logic, the ACR system, the interactive application, and the game play object detection system. In some embodiments, the broadcast detection logic and game play object detection systems run on the XR device as they both utilize the camera feeds from the XR device to define the location of the display 101 and the action in the broadcast itself. Removing the extra step of transmitting the camera feed to these systems greatly reduces overlay rendering latency.

The overlay system 100 may minimize the impact of latency and/or potentially leverage the latency itself if the server of the ACR system is sufficiently ahead of the content feed displayed on other devices. The XR device, as discussed, may, in some embodiments, be responsible for detecting the video display and connecting it with available simultaneous localization and mapping (SLAM) data to define the physical space the XR device and the display are located in. This tracking enables the overlay system 100 to efficiently and continuously track the display once the overlay system 100 has identified it.

In some embodiments, once the ACR system has determined that the content is relevant to the overlay system 100, for example, if the content is a specific sporting event, and that there are active participation selections available, the overlay system 100 will update the display of the XR device with both the latency from the live action and the available participation selections. In some embodiments, the updated display of the XR device may also include each selection's associated information or metadata.

In some embodiments in which there is latency between the XR device display and the live event, the ACR system also provides timing information related to actions in the event before the XR device displays the actions. In some embodiments, when the client and server systems both know the latency, the interactive application may adjust the available participation selections based on the latency. For example, if the decision time for a selection is less than the latency, the overlay system 100 may determine that that selection is not available.

In some embodiments, properly rendering graphics requires an understanding of the camera position relative to the space in which the content takes place (for example, a football field, performance stage, or studio) so that the graphics and other imagery can be correctly projected onto the three dimensional surfaces that make up the image, such as the playing field and players.

Additionally, in some embodiments, the overlay system 100 could utilize custom shading to ensure the overlaid rendered graphics match the content of the display. The overlay system 100 may use a video detection system to create a masking layer that adjusts shading of overlay graphics to match the lighting and reflectiveness of the primary display. This mask may simplify shading to allow the XR device to locally manage detection and rendering, minimizing any additional data feeds or network traffic.

In some embodiments in which the XR device manages the video object detection and rendering locally, the overlay system 100 reduces the amount of network traffic from the headset. In some such embodiments the overlay system 100 reduces traffic from continual updates to periodic screenshot updates from the XR device to the ACR system. In some embodiments, additional data, such as user transactions, updates from an application server, ACR updates on new latency timing, and camera or scene changes in the video feed, may be included in these periodic updates.

In some embodiments, if there is low latency between a local video feed and the ACR system, or if the XR device is not capable of running the object detection natively, an application or its edge servers may detect objects and/or render graphics for display via a cloud or edge. This scenario requires a low latency and higher bandwidth connection to the XR device to deliver the overlay graphics or fully rendered video. Such embodiments take advantage of the latency between the ACR system and the XR device. The difference in latency may allow additional time for the ACR system to run the object detection and apply overlay graphics for each active participation selection, and then deliver the overlay graphics ahead of the display content stream so that the XR device can display the overlay over the displayed content stream synchronously.

In some embodiments, e.g., with advertising scenarios, the overlay system 100 may implement an advertising system as the interactive application. The advertising system would receive the relevant ACR system and participant data to select advertisements to place with the content stream. The advertising system may then send a selected advertisement to the overlay system 100 for rendering as an overlay on the XR device. In some embodiments, the advertisement may be, for example, supplemental content to a live commercial, such as additional information about a product, including, for example, an interactive link to contact the nearest dealer, or a location-based pricing incentive.

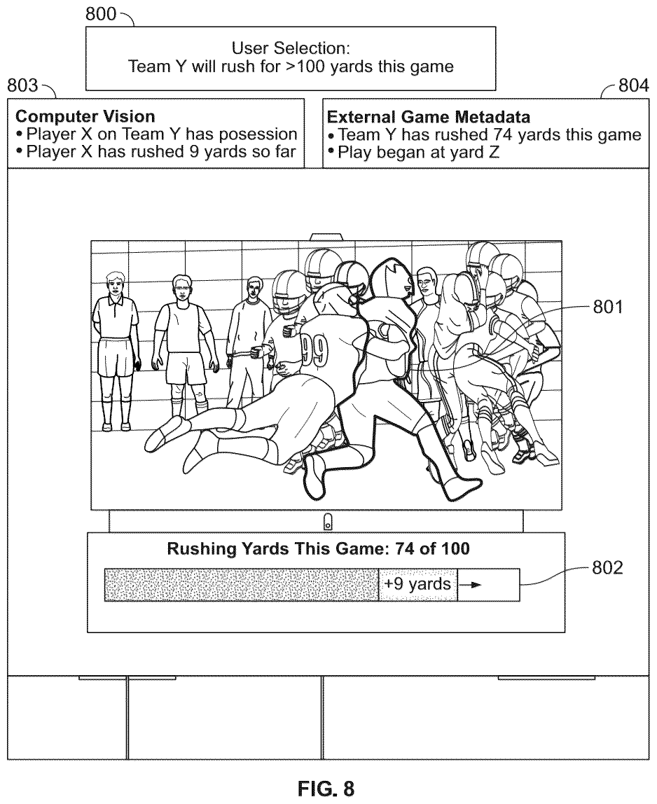

FIG. 7A depicts a live commercial 701 advertising a car. FIG. 7B shows the same commercial 701 viewed through an XR device, such as XR device 103, in communication with the overlay system 100. The overlay system in FIG. 7B captures, through an XR device, at least a portion of the live commercial 701 and identifies the live commercial 701 using an ACR system. The overlay system 100 receives information about a viewer, such as location data, and information about the commercial 701, that is, content state data 106, that location-specific information regarding inventory is available. In response to the received data on the viewer and commercial 701, system 100 generates for presentation a location-specific overlay 702 that includes information relevant to the location of the viewer. In FIG. 7B, the overlay system 100 shows the same commercial 701 as in FIG. 7A with personalized overlay 702 describing availability local to the viewer.

In some embodiments, the overlay system 100 may insert three-dimensional objects into a scene, via an overlay on the XR device display, based on the displayed content stream and participant profile data. In some embodiments, the overlay system 100 may retrieve contextual information relevant to the participant (for example, participant history or fantasy sports team makeup), and present this information as an overlay in the XR device. In order to present such information accurately, the overlay system 100 must integrate content state data captured locally with data provided externally by the interaction application, as well as with any relevant features from third-party services.

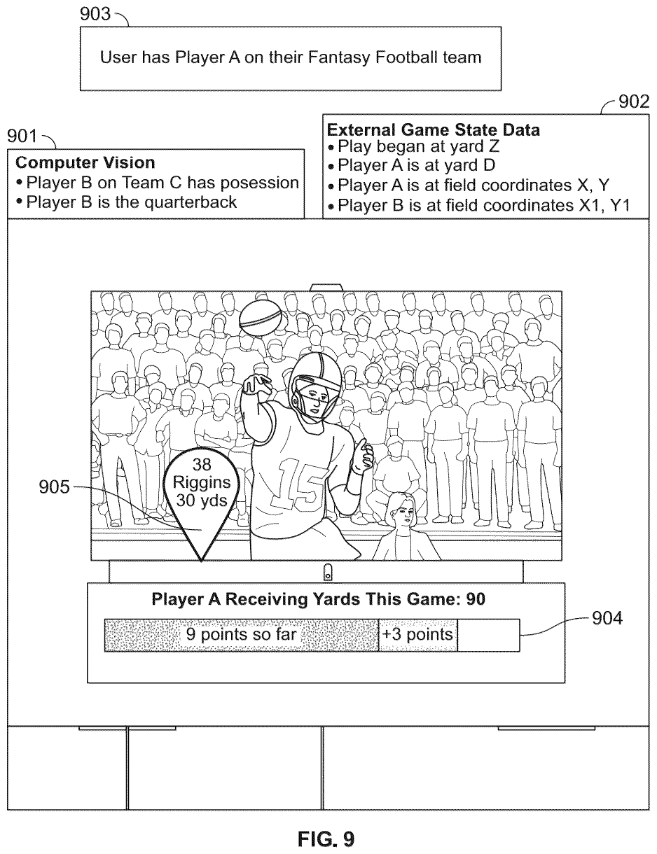

FIG. 8 depicts an example embodiment in which the system overlay 100 integrates third-party data into an overlay. In FIG. 8, for example, third-party data 800 indicates that a user has expressed interest in the statistic that Team Y will rush over 100 yards this game. In one example, the overlay system 100 may retrieve information from a polling service that a participant has selected an option that Team Y will rush at least 100 yards in a football game. In this case, the overlay system 100 may retrieve the participant's selection, that is the user's expressed interest, from, for example, an interactive application.

In some embodiments, the overlay system 100 may also supplement the third-party data 800 with low-latency game-status data from a computer vision service, such as a computer vision algorithm integrated within the XR device. In FIG. 8, using computer vision algorithms, overlay system 100 determines information 803 that player X on Team Y has possession of the ball, and that player X has rushed nine yards so far in the game. External game metadata 804, for example, as sent from a content provider or other source, further indicates that Team Y has rushed 74 yards this game and that the current play began at yard Z. The overlay system 100 may then determine that Team Y has an opportunity to rush additional yards and that such an event is of interest to the viewer. The overlay system 100 may then generate an overlay 801 highlighting the event. For example, to highlight the event, the overlay system 100 of FIG. 8 highlights player X, a key player at the moment. The overlay system 100 also generates a second overlay 802, which is displayed textual information. The XR device, via system 100, then displays the overlay 801 highlighting player X, who has possession of the ball for Team Y. The XR device also displays a second overlay 802 indicating rushing yards for Team Y at this time in a game and a graphic representing the remaining rushing yards until the viewer's interest of 100 rushing yards is met.

The overlay system 100 may prioritize overlays based on one or more individual features such as polling value and/or fantasy football point amount. The overlay system 100 may also prioritize overlays based on, for example, overlay type, to prevent multiple overlays of the same type being presented at once. If eye gaze data of a participant or viewer is available, the overlay system 100 may prioritize overlays based on patterns of eye movement. For example, the overlay system 100 may recognize that a viewer has spent a certain percentage of time in the last thirty seconds looking at a specific player. If that percentage is above a threshold value and the player is associated with an action participation selection, the overlay system 100 may increase the priority level of overlays related to that participation selection.

In some embodiments, the overlay system 100 may determine content state data parameters directly via the XR device if the desired data is, for example, not otherwise available, only available at a latency higher than a threshold value, or at a latency that represents an improvement above a threshold. For example, content state data for a football game may indicate which player is currently in possession of the ball but at a 150 ms latency. In some embodiments, where the XR device (or other local and/or network system components) is able to conduct optical character recognition (OCR) to identify the player number from their jersey quickly (e.g., in 80 ms), the system may use content state data provided via the XR device in place of and/or supplementing other data.

In some embodiments, each content state data parameter may have an associated confidence level, and the overlay system 100 may apply a minimum confidence threshold to use such parameters. In some embodiments, the overlay system 100 may integrate content state data captured locally (for example, through visual sensors detecting on-screen events) with data provided by a third party, such as a betting service or sports organization.

Data available from major sports organizations, such as the NFL and NBA, may be available in a live stream and supplement locally captured data in system 100. For example, using sensors on players, balls, and courts/fields, these organizations may generate time series data such as the precise location of every player, position of the ball, and game events (for example, points scored, shot clock, first down), which the overlay system 100 may integrate into an overlay or decisions regarding overlays.

In some embodiments, the overlay system 100 may generate a virtual camera view based on active camera data provided by content state data or inferred through computer vision algorithms or other means. In some embodiments, the XR device may then, for example, detect a specific player on the display throwing a ball, identify the player as of interest, retrieve that player's current position, and generate a camera view following the player as a result.

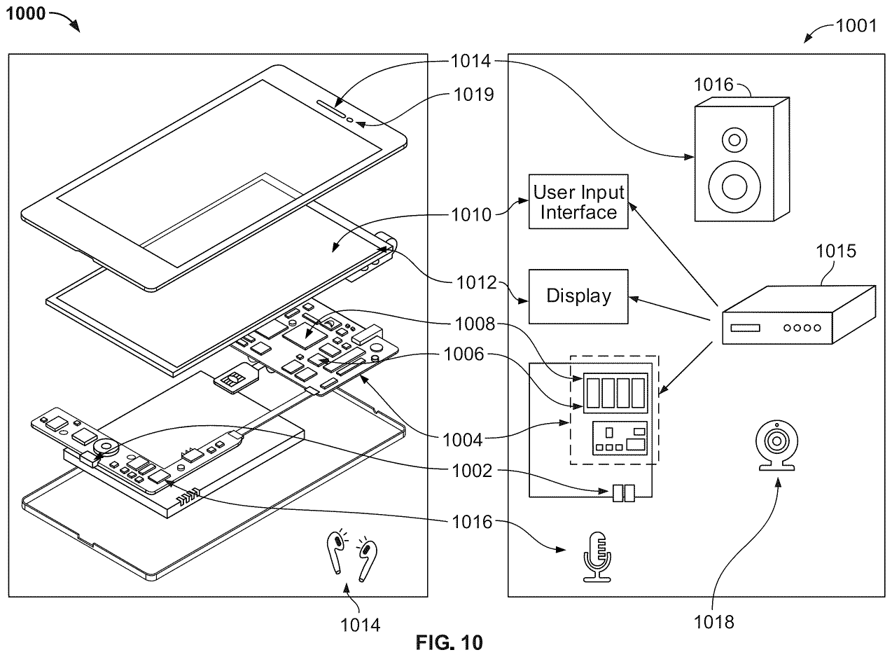

A virtual camera view is shown in FIG. 9. FIG. 9 shows player B throwing the ball. Computer vision algorithm data 901 within system 100 detects that player B on Team C has possession of the ball and that player B is the quarterback. Content state data 902 indicates that a play began at yard Z, player A is at yard D, player A is at field coordinates (X1, Y1), and that player B is at field coordinates (X2, Y2). Further, the overlay system 100 receives data 903 that player A is on the fantasy football team of a viewer and thereof of interest to that viewer. Using the computer vision algorithm data 901, content state data 902, and data 903 regarding the viewer, the overlay system 100 generates overlays 904, 905 of player A indicating information and position, respectively, of player A. The overlay system 100 may generate overlays 904, 905 of player A whether player A is on-screen or off-screen at any given moment.

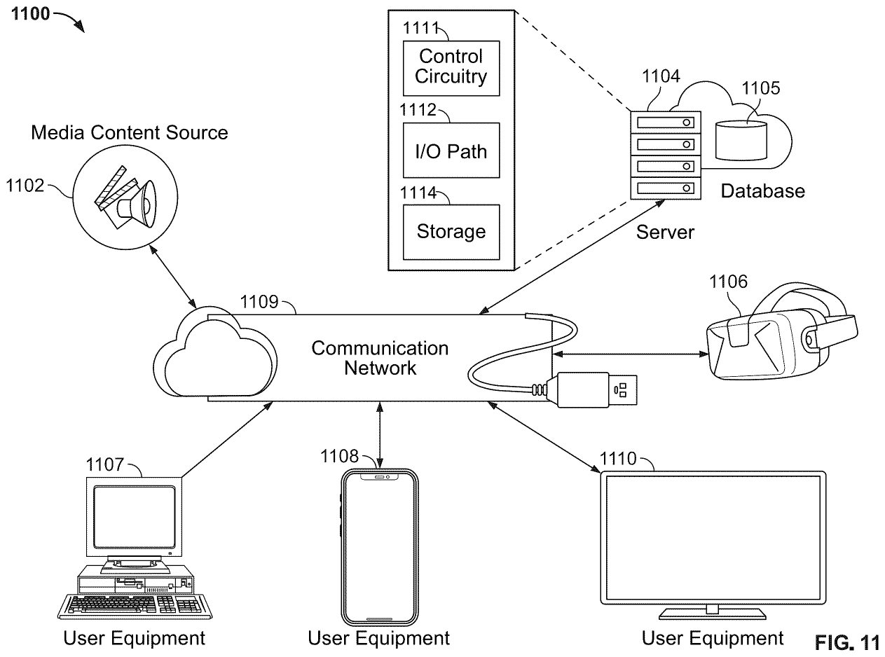

FIGS. 10-11 depict illustrative devices, systems, servers, and related hardware for extending selectable object capability to a captured image, in accordance with some embodiments of the present disclosure. In some embodiments, any suitable combination of the components of FIGS. 10-11 may be employed to perform the techniques described in FIGS. 1-9 and 12.

FIGS. 10-11 depict illustrative devices, systems, servers, and related hardware for providing in-game assistance in a video game, in accordance with some embodiments of this disclosure. FIG. 10 shows generalized embodiments of illustrative computing devices 1000 and 1001, which may correspond to, e.g., a smart phone; a tablet; a laptop computer; a personal computer; a desktop computer; a smart television; a smart watch or wearable device; smart glasses; a stereoscopic display; a wearable camera; XR glasses; XR goggles; a stereoscopic display; XR glasses; an XR HMD; or any other suitable computing device; or any combination thereof. In another example, computing device 1001 may be a user television equipment system or device. In some embodiments, computing devices 1000 and 1001 may correspond to, e.g., user device 102.

User television equipment device 1001 may include set-top box 1015. In some embodiments, element 1015 may correspond to a video game console (e.g., Xbox, Play Station, or any other suitable gaming console). Set-top box 1015 may be communicatively connected to microphone 1016, Audio output equipment (e.g., speaker or headphones 1014), and display 1012. In some embodiments, microphone 1016 may receive audio corresponding to a voice of a user providing input. In some embodiments, display 1012 may be a television display or a computer display. In some embodiments, set-top box 1015 may be communicatively connected to user input interface 1010. In some embodiments, user input interface 1010 may be a remote control device. Set-top box 1015 may include one or more circuit boards. In some embodiments, the circuit boards may include control circuitry, processing circuitry, and storage (e.g., RAM, ROM, hard disk, removable disk, etc.). In some embodiments, the circuit boards may include an input/output path. More specific implementations of computing devices are discussed below in connection with FIG. 10. In some embodiments, computing device 1000 may comprise any suitable number of sensors (e.g., gyroscope or gyrometer, or accelerometer, etc.), and/or a GPS module (e.g., in communication with one or more servers and/or cell towers and/or satellites) to ascertain a location of computing device 1000. In some embodiments, computing device 1000 comprises a rechargeable battery that is configured to provide power to the components of the device.

Each one of computing device 1000 and computing device 1001 may receive content and data via input/output (I/O) path 1002. I/O path 1002 may provide content (e.g., broadcast programming, on-demand programming, Internet content, content available over a local area network (LAN) or wide area network (WAN), and/or other content) and data to control circuitry 1004, which may comprise processing circuitry 1006 and storage 1008. Control circuitry 1004 may be used to send and receive commands, requests, and other suitable data using I/O path 1002, which may comprise I/O circuitry. I/O path 1002 may connect control circuitry 1004 (and specifically processing circuitry 1006) to one or more communications paths (described below). I/O functions may be provided by one or more of these communications paths, but are shown as a single path in FIG. 10 to avoid overcomplicating the drawing. While set-top box 1015 is shown in FIG. 10 for illustration, any suitable computing device having processing circuitry, control circuitry, and storage may be used in accordance with the present disclosure. For example, set-top box 1015 may be replaced by, or complemented by, a personal computer (e.g., a notebook, a laptop, a desktop), a smartphone (e.g., computing device 1000), an XR device; a tablet; a network-based server hosting a user-accessible client device; a non-user-owned device; any other suitable device; or any combination thereof.

Control circuitry 1004 may be based on any suitable control circuitry such as processing circuitry 1006. As referred to herein, control circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 1004 executes instructions for the overlay system 100 stored in memory (e.g., storage 1008). Specifically, control circuitry 1004 may be instructed by the overlay system 100 to perform the functions discussed above and below. In some implementations, processing or actions performed by control circuitry 1004 may be based on instructions received from the overlay system 100.

In client/server-based embodiments, control circuitry 1004 may include communications circuitry suitable for communicating with a server or other networks or servers. The overlay system 100 may be a stand-alone application implemented on a device or a server.

The overlay system 100 may be implemented as software or a set of executable instructions. The instructions for performing any of the embodiments discussed herein of the overlay system 100 may be encoded on non-transitory computer-readable media (e.g., a hard drive, random-access memory on a DRAM integrated circuit, read-only memory on a BLU-RAY disk, etc.). For example, in FIGS. 1A-1B, the instructions may be stored in storage 1008, and executed by control circuitry 1004 of a device 1000.

In some embodiments, the overlay system 100 may be a client/server application where only the client application resides on a device (e.g., user device 102), and a server application resides on an external server (e.g., server 1004). For example, the overlay system 100 may be implemented partially as a client application on control circuitry 1004 of device 1000 and partially on server 1104 as a server application running on control circuitry 1111. Server 1104 may be a part of a local area network with one or more of devices 1000, 1001 or may be part of a cloud computing environment accessed via the Internet. In a cloud computing environment, various types of computing services for performing searches on the Internet or informational databases, providing video communication capabilities, providing storage (e.g., for a database) or parsing data are provided by a collection of network-accessible computing and storage resources (e.g., server 1104 and/or an edge computing device), referred to as “the cloud.”

Device 1000 may be a cloud client that relies on the cloud computing capabilities from server 1104 to determine whether processing (e.g., at least a portion of virtual background processing and/or at least a portion of other processing tasks) should be offloaded from the mobile device, and facilitate such offloading. When executed by control circuitry of server 1104, the overlay system 100 may instruct control circuitry 1111 to perform processing tasks for the client device and facilitate the generation of encoding data. The client application may instruct control circuitry 1004 to determine whether processing should be offloaded. Control circuitry 1004 may include communications circuitry suitable for communicating with a server, edge computing systems and devices, a table or database server, or other networks or servers The instructions for carrying out the above-mentioned functionality may be stored on a server (which is described in more detail in connection with FIG. 11. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communication networks or paths (which is described in more detail in connection with FIG. 11). In addition, communications circuitry may include circuitry that enables peer-to-peer communication of computing devices, or communication of computing devices in locations remote from each other (described in more detail below).

Memory may be an electronic storage device provided as storage 1008 that is part of control circuitry 1004. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 2D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 1008 may be used to store various types of content described herein as well as the overlay system 100 data described above. Nonvolatile memory may also be used (e.g., to launch a boot-up routine and other instructions). Cloud-based storage, described in more detail in relation to FIG. 11, may be used to supplement storage 1008 or instead of storage 1008.

Control circuitry 1004 may include video generating circuitry and tuning circuitry, such as one or more analog tuners, or HEVC decoders or any other suitable digital decoding circuitry, high-definition tuners, or any other suitable tuning or video circuits or combinations of such circuits. Encoding circuitry (e.g., for converting over-the-air, analog, or digital signals to SHVC or any other suitable signals for storage) may also be provided. Control circuitry 1004 may also include scaler circuitry for upconverting and down converting content into the preferred output format of computing device 1000. Control circuitry 1004 may also include digital-to-analog converter circuitry and analog-to-digital converter circuitry for converting between digital and analog signals. The tuning and encoding circuitry may be used by computing device 1000, 1001 to receive and to display, to play, or to record content. The tuning and encoding circuitry may also be used to receive video communication session data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 1008 is provided as a separate device from computing device 1000, the tuning and encoding circuitry (including multiple tuners) may be associated with storage 1008.

Control circuitry 1004 may receive instruction from a user by way of user input interface 1010. User input interface 1010 may be any suitable user interface, such as a remote control, mouse, trackball, keypad, keyboard, touch screen, touchpad, stylus input, joystick, voice recognition interface, or other user input interfaces. Display 1012 may be provided as a stand-alone device or integrated with other elements of each one of computing device 1000 and computing device 1001. For example, display 1012 may be a touchscreen or touch-sensitive display. In such circumstances, user input interface 1010 may be integrated with or combined with display 1012. In some embodiments, user input interface 1010 includes a remote-control device having one or more microphones, buttons, keypads, any other components configured to receive user input or combinations thereof. For example, user input interface 1010 may include a handheld remote-control device having an alphanumeric keypad and option buttons. In a further example, user input interface 1010 may include a handheld remote-control device having a microphone and control circuitry configured to receive and identify voice commands and transmit information to set-top box 1015.

Audio output equipment 1014 may be integrated with or combined with display 1012. Display 1012 may be one or more of a monitor, a television, a liquid crystal display (LCD) for a mobile device, amorphous silicon display, low-temperature polysilicon display, electronic ink display, electrophoretic display, active matrix display, electro-wetting display, electro-fluidic display, cathode ray tube display, light-emitting diode display, electroluminescent display, plasma display panel, high-performance addressing display, thin-film transistor display, organic light-emitting diode display, surface-conduction electron-emitter display (SED), laser television, carbon nanotubes, quantum dot display, interferometric modulator display, or any other suitable equipment for displaying visual images. A video card or graphics card may generate the output to the display 1012. Audio output equipment 1014 may be provided as integrated with other elements of each one of computing device 1000 and computing device 1001 or may be stand-alone units. An audio component of videos and other content displayed on display 1012 may be played through speakers (or headphones) of audio output equipment 1014. In some embodiments, audio may be distributed to a receiver (not shown), which processes and outputs the audio via speakers of audio output equipment 1014. In some embodiments, for example, control circuitry 1004 is configured to provide audio cues to a user, or other audio feedback to a user, using speakers of audio output equipment 1014. There may be a separate microphone 1016 or audio output equipment 1014 may include a microphone configured to receive audio input such as voice commands or speech. For example, a user may speak letters or words or terms or numbers that are received by the microphone and converted to text by control circuitry 1004. In a further example, a user may voice commands that are received by a microphone and recognized by control circuitry 1004. Camera 1018 may be any suitable video camera integrated with the equipment or externally connected. Camera 1018 may be a digital camera comprising a charge-coupled device (CCD) and/or a complementary metal-oxide semiconductor (CMOS) image sensor. Camera 1018 may be an analog camera that converts to digital images via a video card.

The overlay system 100 may be implemented using any suitable architecture. For example, it may be a stand-alone application wholly implemented on each one of computing device 1000 and computing device 1001. In such an approach, instructions of the application may be stored locally (e.g., in storage 1008), and data for use by the application is downloaded on a periodic basis (e.g., from an out-of-band feed, from an Internet resource, or using another suitable approach). Control circuitry 1004 may retrieve instructions of the application from storage 1008 and process the instructions to provide video conferencing functionality and generate any of the displays discussed herein. Based on the processed instructions, control circuitry 1004 may determine what action to perform when input is received from user input interface 1010. For example, movement of a cursor on a display up/down may be indicated by the processed instructions when user input interface 1010 indicates that an up/down button was selected. An application and/or any instructions for performing any of the embodiments discussed herein may be encoded on computer-readable media. Computer-readable media includes any media capable of storing data. The computer-readable media may be non-transitory including, but not limited to, volatile and non-volatile computer memory or storage devices such as a hard disk, floppy disk, USB drive, DVD, CD, media card, register memory, processor cache, Random Access Memory (RAM), etc.

Control circuitry 1004 may allow a user to provide user profile information or may automatically compile user profile information. For example, control circuitry 1004 may access and monitor network data, video data, audio data, processing data, participation data from a conference participant profile. Control circuitry 1004 may obtain all or part of other user profiles that are related to a particular user (e.g., via social media networks), and/or obtain information about the user from other sources that control circuitry 1004 may access. As a result, a user can be provided with a unified experience across the user's different devices.

In some embodiments, the overlay system 100 is or comprises a client/server-based application. Data for use by a thick or thin client implemented on each one of computing device 1000 and computing device 1001 may be retrieved on-demand by issuing requests to a server remote to each one of computing device 1000 and computing device 1001. For example, the remote server may store the instructions for the application in a storage device. The remote server may process the stored instructions using circuitry (e.g., control circuitry 1004) and generate the displays discussed above and below. The client device may receive the displays generated by the remote server and may display the content of the displays locally on computing device 1000. This way, the processing of the instructions is performed remotely by the server while the resulting displays (e.g., that may include text, a keyboard, or other visuals) are provided locally on computing device 1000. Computing device 1000 may receive inputs from the user via input interface 1010 and transmit those inputs to the remote server for processing and generating the corresponding displays. For example, computing device 1000 may transmit a communication to the remote server indicating that an up/down button was selected via input interface 1010. The remote server may process instructions in accordance with that input and generate a display of the application corresponding to the input (e.g., a display that moves a cursor up/down). The generated display is then transmitted to computing device 1000 for presentation to the user.

In some embodiments, the overlay system 100 may be downloaded and interpreted or otherwise run by an interpreter or virtual machine (run by control circuitry 1004). In some embodiments, the overlay system 100 may be encoded in the ETV Binary Interchange Format (EBIF), received by control circuitry 1004 as part of a suitable feed, and interpreted by a user agent running on control circuitry 1004. For example, the overlay system 100 may be an EBIF application. In some embodiments, the overlay system 100 may be defined by a series of JAVA-based files that are received and run by a local virtual machine or other suitable middleware executed by control circuitry 1004. In some of such embodiments (e.g., those employing H.265, SHVC or any other suitable digital media encoding schemes), the overlay system 100 may be, for example, encoded and transmitted in using an SHVC with the SHVC audio and video packets of a program.

FIG. 11 is a diagram of an illustrative system 1100, in accordance with some embodiments of this disclosure. Computing devices 1107, 1108, and/or 1110 (which may correspond to, e.g., computing device 1000 or 1001) may be coupled to communication network 1109. Communication network 1109 may be one or more networks including the Internet, a mobile phone network, mobile voice or data network (e.g., a 5G, 4G, or LTE network), cable network, public switched telephone network, or other types of communication network or combinations of communication networks. Paths (e.g., depicted as arrows connecting the respective devices to the communication network 1109) may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. Communications with the client devices may be provided by one or more of these communications paths but are shown as a single path in FIG. 11 to avoid overcomplicating the drawing.

Although communications paths are not drawn between computing devices, these devices may communicate directly with each other via communications paths as well as other short-range, point-to-point communications paths, such as USB cables, IEEE 1394 cables, wireless paths (e.g., Bluetooth, infrared, IEEE 602-11x, etc.), or other short-range communication via wired or wireless paths. The computing devices may also communicate with each other directly through an indirect path via communication network 1109.

System 1100 may comprise media content source 1102, one or more servers 1104, and/or one or more edge computing devices. In some embodiments, the overlay system 100 may be executed at one or more of control circuitry 1111 of server 1104 (and/or control circuitry of computing devices 1107, 1108, 1110 and/or control circuitry of one or more edge computing devices). In some embodiments, the media content source and/or server 1104 may be configured to host or otherwise facilitate video communication sessions between computing devices 1107, 1108, 1110 and/or any other suitable computing devices, and/or host or otherwise be in communication (e.g., over network 1109) with one or more social network services.

In some embodiments, server 1104 may include control circuitry 1111 and storage 1114 (e.g., RAM, ROM, Hard Disk, Removable Disk, etc.). Storage 1114 may store one or more databases. Server 1104 may also include an input/output path 1112. I/O path 1112 may provide video conferencing data, device information, or other data, over a local area network (LAN) or wide area network (WAN), and/or other content and data to control circuitry 1111, which may include processing circuitry, and storage 1114. Control circuitry 1111 may be used to send and receive commands, requests, and other suitable data using I/O path 1112, which may comprise I/O circuitry. I/O path 1112 may connect control circuitry 1111 (and specifically control circuitry) to one or more communications paths.

Control circuitry 1111 may be based on any suitable control circuitry such as one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry 1111 may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 1111 executes instructions for an emulation system application stored in memory (e.g., the storage 1114). Memory may be an electronic storage device provided as storage 1114 that is part of control circuitry 1111.

In some embodiments, server 1104 may be included in a CDN, which may include origin servers, data centers, central servers, and/or edge servers, and/or any other suitable components. Computing devices 1107, 1108, 1110 may comprise one or more decoders, which may comprise any suitable combination of hardware and/or software configured to convert data in a coded form to a form that is usable as video signals and/or audio signals or any other suitable type of data signal, or any combination thereof. The encoder may comprise any suitable combination of hardware and/or software configured to process data to reduce storage space required to store the data and/or bandwidth required to transmit the image data, while minimizing the impact of the encoding on the quality of the video or one or more images. The encoder and/or decoder may utilize any suitable algorithms and/or compression standards and/or codecs. In some embodiments, the encoder and/or decoder may be a virtual machine that may reside on one or more physical servers that may or may not have specialized hardware, and/or a cloud service may determine how many of these virtual machines to use based on established thresholds. In some embodiments, separate audio and video encoders and/or decoders may be employed.

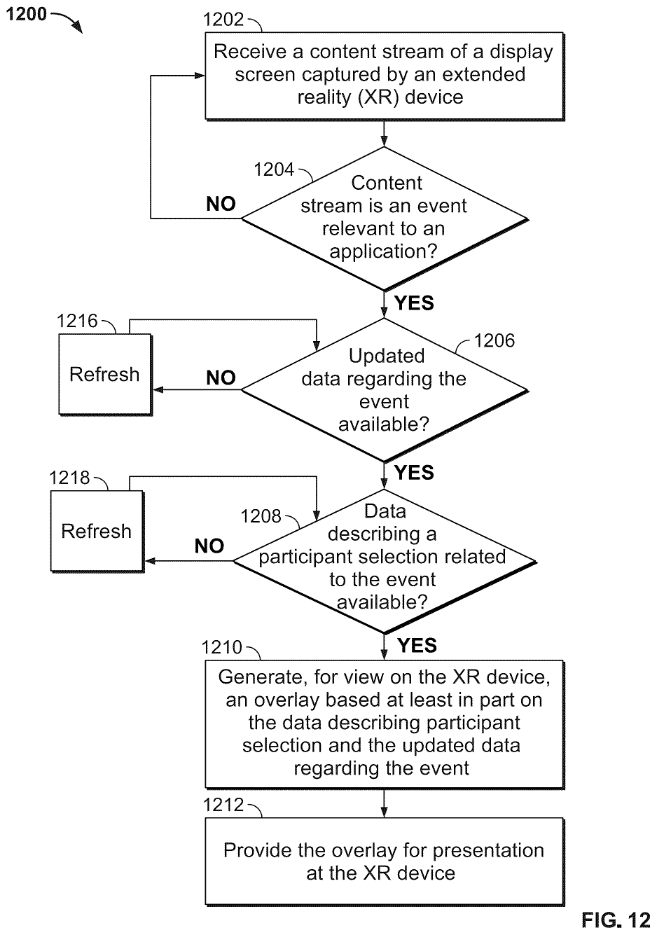

FIG. 12 depicts an illustrative flowchart of a process 1200 for displaying customized and content-specific overlays, in accordance with some embodiments of this disclosure. In various embodiments, the individual steps of process 1200 may be implemented by one or more components of the devices, methods, and systems of FIGS. 1-11 and may be performed in combination with any of the other processes and aspects described herein. Although the present disclosure may describe certain steps of processes 1200 (and of other processes described herein) as being implemented by certain components of the devices, methods, and systems of FIGS. 1-11, this is for purposes of illustration only, and it should be understood that other components of the devices, methods, and systems of FIGS. 1-11 may implement those steps instead.

In process 1200, at step 1202, control circuitry (e.g., control circuitry 1004 of computing device 1000 of FIG. 10 and/or control circuitry 1111 of server 1104 of FIG. 11) may receive a content stream displayed on a display screen captured by an extended reality (XR) device. The content stream may be content such as content 102 shown in FIG. 1 and include a television show, a live performance, a sporting event, a movie, or any other audio-visual content. The display screen may be a display of a television, laptop, tablet, smartphone, desktop computer, projector, or other device capable of presenting audio-visual content as shown as display 101 in FIG. 1. In some embodiments, the XR device, seen in FIG. 1 as XR device 103, may capture the content through an integrated camera or other sensor. In some embodiments, the XR device displays the content through an integrated XR display within the XR device.

At step 1204, the control circuitry may identify whether the content stream is an event relevant to an interactive application. In some embodiments, the control circuitry may identify the content stream using an ACR system, discussed above. In some embodiments, the control circuitry may send the captured content to the ACR system via a wired or wireless network for analysis. In some embodiments, the control circuitry is in communication with the interactive application and may receive information from or send information to the interactive application for help identifying the content. In some embodiments, the display screen or device connected thereto may send information to the control circuitry to contribute to the identification process as well. If the content stream is not relevant to an application, the process returns to step 1202 to continue to receive the content stream. In some embodiments, alternatively, the process performs no action if the content stream or event is not relevant to the application.

At step 1206, the control circuitry may determine, based at least in part on the identifying, if updated data regarding the event is available. In some embodiments, the control circuitry is in communication with a database or repository storing information regarding the event and receives the updated data from that database or repository. In some embodiments, the control circuitry receives the updated data directly through image or audio processing. The XR device, display screen, or other system may implement the image or audio processing. If the data is not available, the control circuitry reloads its data streams at 1216 and returns to step 1206 to continue to monitor for updated data. If the data is available, the process moves to step 1208.

At step 1208, the control circuitry may determine if, via the interactive application, data describing a participant selection related to the event is available. In some embodiments, the participant selection may be, for example, a selected response to a poll or trivia selection, a bet selection, a fantasy sports selection, or other interactive element. If the data is not available, the control circuitry reloads its data streams at 1218 and returns to step 1208 to continue to monitor for data describing the participant selection. If the data is available, the process moves to step 1210.

At step 1210, the control circuitry may generate, for view on the XR device, an overlay based at least in part on the data describing participant selection and the updated data regarding the event. In some embodiments, the overlay includes a notification of an update to the participant selection based on the updated data regarding the event. In some embodiments, the overlay highlights elements of the event, such as key players or landmarks on a field. Finally, at step 1212, the control circuitry may provide the overlay for presentation at the XR device. The XR device may then display, for example, on an integrated digital display, the event with the overlay over it, effectively presenting the event with additional information.

The processes discussed above and below are intended to be illustrative and not limiting. One skilled in the art would appreciate that the steps of the processes discussed herein may be omitted, modified, combined and/or rearranged, and any additional steps may be performed without departing from the scope of the invention. More generally, the above disclosure is meant to be illustrative and not limiting. Only the claims that follow are meant to set bounds as to what the present invention includes. Furthermore, it should be noted that the features and limitations described in any some embodiments, may be applied to any other embodiment herein, and flowcharts or examples relating to some embodiments, may be combined with any other embodiment in a suitable manner, done in different orders, or done in parallel. In addition, the systems, methods, apparatuses, and computer-readable media described herein may be performed in real time or near real time. It should also be noted that the systems and/or methods described above may be applied to, or used in accordance with, other systems and/or methods. Throughout the specification the phrases “in response to” and “based on” shall be understood to have a broad meaning unless context requires otherwise. For example, “in response to” can refer to a step that is in direct or indirect response to a prior step, and “based on” can refer to a step that is based at least in part on a prior step.

1. A method comprising:
receiving a content stream displayed on a display screen captured by an extended reality (XR) device;
identifying the content stream as an event relevant to an interactive application;
receiving, based at least in part on the identifying, updated data regarding the event;
receiving, via the interactive application, data describing a participant selection related to the event;
generating, for view on the XR device, an overlay based at least in part on the data describing participant selection and the updated data regarding the event; and
providing the overlay for presentation at the XR device.

2. The method of claim 1 wherein the updated data regarding the event includes data indicating a network latency of the event on the XR device; and
further comprising:
receiving, via the interactive application and based at least in part on the network latency, one or more participant options for selection; and
providing for presentation the one or more participant options for selection, wherein the participant selection is a selection of at least one of the one or more participant options.

3. The method of claim 1 further comprising:
identifying an element of the event relevant to the participant selection; and
wherein the overlay for the display screen emphasizes the element of the event.

4. The method of claim 3 wherein identifying an element of the event relevant to the participant selection is based at least in part on a semantic segmentation of the content stream.

5. The method of claim 3 further comprising:
during the event, continuously tracking elements of the event; and
wherein the overlay for the display screen is based at least in part on the continuous tracking.

6. The method of claim 1 wherein generating the overlay includes generating a masking layer which matches lighting of the overlay to lighting of the content stream.

7. The method of claim 1 further comprising:
detecting a change in a field of view of the content stream relative to the event; and
dynamically adjusting for presentation a position of the overlay on the display screen based on the detecting a change in the field of view of the content stream relative to the event.

8. The method of claim 1 further comprising:
identifying an element of the event relevant to the participant selection, and wherein the updated data of the event includes a position of the identified element within a three-dimensional space of the event; and
generating a custom camera perspective of the event based on the position of the identified element.

9. The method of claim 1 further comprising:
determining, based at least in part on one of tracked eye movement, a current participant selection, or a participant history, a priority level of the overlay; and
wherein providing for presentation on the XR device the overlay is based at least in part on the determined priority level.

10. The method of claim 1 further comprising:
receiving a second updated data regarding the event;
updating the overlay based at least in part on the second updated data regarding the event; and
providing for presentation on the XR device the updated overlay.

11. The method of claim 1 further comprising:
receiving, via the XR device, a location within a physical space of the display screen relative to the XR device; and
wherein generating the overlay for the display screen for view on the XR device is based at least in part on the location of the display screen.

12. The method of claim 1 wherein the identifying the content stream as an event relevant to the interactive application is based at least in part on an analysis of at least a portion of a visual or an audio component of the captured content stream by the XR device.

13. The method of claim 1 wherein the identifying the content stream as an event relevant to the interactive application is based at least in part on metadata information received from the display screen.

14. A system comprising:
processing circuitry configured to:
receive a content stream displayed on a display screen captured by an extended reality (XR) device;
identify the content stream as an event relevant to an interactive application;
receive, based at least in part on the identifying, updated data regarding the event;
receive, via the interactive application, data describing a participant selection related to the event;
generate, for view on the XR device, an overlay based at least in part on the data describing participant selection and the updated data regarding the event; and
provide the overlay for presentation at the XR device.

15. The system of claim 14 wherein the updated data regarding the event includes data indicating a network latency of the event on the XR device; and
the processing circuitry further configured to:
receive, via the interactive application and based at least in part on the network latency, one or more participant options for selection; and
provide for presentation the one or more participant options for selection, wherein the participant selection is a selection of at least one of the one or more participant options.

16. The system of claim 14 the processing circuitry further configured to:
Identify an element of the event relevant to the participant selection; and
wherein the overlay for the display screen emphasizes the element of the event.

17. The system of claim 16 wherein identifying an element of the event relevant to the participant selection is based at least in part on a semantic segmentation of the content stream.

18. The system of claim 16 the processing circuitry further configured to:
during the event, continuously track elements of the event; and
wherein the overlay for the display screen is based at least in part on the continuous tracking.

19. The system of claim 14 wherein generating the overlay includes generating a masking layer which matches lighting of the overlay to lighting of the content stream.

20. The system of claim 14 further the processing circuitry further configured to:
detect a change in a field of view of the content stream relative to the event; and
dynamically adjust for presentation a position of the overlay on the display screen based on the detecting a change in the field of view of the content stream relative to the event.

21-53. (canceled)
